(19) United States
(12) Patent Application Publication
(10) Pub. No.: US 2020/0281067 A1
(43) Pub. Date: Sep. 3, 2020

(54) A POWER GENERATOR USING NEUTRON CAPTURE

(71) Applicant: SPALLACATCH AB, MALMÖ (SE)

(72) Inventor: Rickard LUNDIN, STOCKHOLM (SE)

(21) Appl. No.: 16/753,856

(22) PCT Filed: Oct. 5, 2018
(86) PCT No.: PCT/EP2018/077230

§ 371 Date: Apr. 6, 2020

(30) Foreign Application Priority Data
Oct. 6, 2017 (SE) 1751232-8
Oct. 6, 2017 (SE) 1751233-6

(51) Int. Cl. H05H 3/06; H05H 1/46; G21B 3/00

(52) U.S. Cl. CPC H05H 3/06; G21G 1/10; G21B 3/002; H05H 1/46

(57) ABSTRACT

A power generator is provided. The power generator includes a housing having two ends of which at least one end is provided with an ion source/pre-accelerator and a main accelerator configured to induce neutron spallation, and a reaction chamber enclosing a fuel, wherein the reaction chamber is arranged to receive free neutrons from the main accelerator.

### TECHNICAL FIELD

The present invention relates to a new type of power generator, in particular it relates to a power generator combining neutron spallation and neutron capture in one and the same unit. Neutrons are produced by accelerating ions up to spallation energies, whereby the neutrons being liberated are subsequently captured by a target of high-yield low-mass elements.

### BACKGROUND

Power production is an area of great attention. From today's extensive use of fossil fuel leaders in politics as well as industry understand the need for alternative power generation, and the process of neutron capture has been suggested as one particularly interesting concept.

For producing energy by neutron capture, it is necessary to provide neutrons. Neutron spallation implies a forced release of neutrons from a nucleus consisting of protons and neutrons. Various techniques are used for neutron spallation, most of them requiring complex and large-scale acceleration apparatuses.

Free neutrons obtained by spallation can be used to produce energy by allowing the neutrons to react with a fuel, capturing the neutron and thus causing an isotope transmutation according to ^{a}X+n=>^{a+1}X+E_{c}, where E_{c} is excess binding mass converted to energy. It should be noted that this process is not to be confused with nuclear fusion, neither “hot” nor “cold”, as the process of neutron capture does not require traversing the Coulomb barrier. By selecting a suitable neutron source, as well as a suitable fuel, it is possible to obtain an energy level of E_{c} well above the energy required for neutron spallation.

Due to various reasons, e.g. as essentially no long-lived radioactive waste is produced, it has been suggested to build devices for energy production based on the principle of neutron capture. However, for small-scale applications it would be advantageous for a minute size accelerator leaving traditional constructional designs for neutron spallation highly unsuitable.

There is thus a need for an improved neutron capture reactor for power generation.

### SUMMARY

An object of the invention is to provide a power generator using a neutron capture reactor overcoming the abovementioned drawbacks of prior art. An idea of the present invention is to provide a reactor being capable of enclosing a fuel, and to expose said fuel to free neutrons obtained by accelerating ions to an elevated energy level.

In particular, a power generator is suggested which is green, clean, sustainable, scalable, and affordable. The power generator is based on one natural and on-going nuclear process. Without leaving any radioactive waste products. It utilizes an everlasting energy source, and it could be realized as a self-contained energy supplier of heat and electricity on or off the grid, on household and/or regional power plant basis.

According to a first aspect, a power generator is provided. The power generator comprises a housing having two ends of which at least one end is provided with a plasma source and ion accelerator configured to induce neutron spallation, and a reaction chamber enclosing a fuel, wherein said reaction chamber is arranged to receive free neutrons from the accelerated ions subjected to neutron spallation.

The power generator may further comprise an ion acceleration chamber.

The ion acceleration chamber and the reaction chamber may be formed as a common chamber, or the ion acceleration chamber may be separate from the reaction chamber.

In an embodiment the reaction chamber is a cylindrical chamber arranged radially outside the ion acceleration chamber.

The power generator may further comprise an outer chamber surrounding said reaction chamber and/or said ion acceleration chamber.

The reaction chamber may contain a variety of suitable fuel/elements with ample energy return and high neutron capture coefficient.

The reaction chamber may contain a fuel mix comprising besides neutron capturing elements, also neutron-producing elements. In the latter case neutron production results from chain reactions induced by internal excess heating and pressure in the reaction chamber.

To optimize neutron capture reactions, the fuel section in single chambers may have a conical shape, whereby the most-narrow section facing the spallator/cathode.

In an embodiment the ion source and the ion pre-accelerator is configured to induce magnetic gradient wave forcing of ions by providing electromagnetic or electrostatic ion cyclotron waves in the diverging magnetic field.

The power generator may comprise an induction coil arranged around said housing for internal heating. The electromagnetic power generated may have frequencies corresponding to a range of internal ion-cyclotron resonance frequencies.

Electrostatic waves, the most effective magnetic gradient wave-acceleration process can be generated from high-voltage sparks, but can also be produced by rapidly alternating voltages applied on suitably located capacitive plates inside said accelerator housing. The advent of electrostatic waves is that magnetic gradient wave-forcing also works well outside resonance, the force increasing with decreasing wave frequency well below resonance.

The length of the housing is between 0.1 m and 1.0 m, preferably between 0.2 m and 0.5 m.

In an embodiment both ends of said housing is provided with a respective plasma source.

The plasma source and ion pre-accelerator may be configured to produce an energetic ion beam.

The ion beam from the pre-accelerator may be extracted from ionized deuterium gas supplied externally, and the reaction chamber may enclose chlorine gas or a solid fuel such as nickel or titanium etc.
According to a second aspect, a reactor assembly is provided. The assembly comprises a frame in which a plurality of reactors according to any embodiment of the first aspect is embedded.

The frame may be made of aluminum.

The frame and the plurality of reactors may be enclosed within a chamber.

According to a third aspect, an ion accelerator for use with a power generator according to the first aspect is provided. The ion accelerator comprises a housing having two ends of which at least one end is provided with a plasma source from which ions are extracted and pre-accelerated, and wherein said ion source is configured to enable magnetic gradient wave-forcing of ions via electromagnetic or electrostatic ion cyclotron waves in the magnetic field.

The ion accelerator may further comprise an induction coil arranged around said housing.

The ion accelerator may further comprise at least one pair of electrostatic spark, or capacitively coupled voltage plates arranged within said housing.

The length of the housing is between 0.1 m and 1.0 m, preferably between 0.3 m and 0.5 m.

In an embodiment both ends of the housing is provided with a respective ion source from which ions are extracted and pre-accelerated.

In an embodiment the plasma and ion source comprises a supply of deuterium.

According to a fourth aspect, a method for causing neutron capture is provided. The method comprises pre-accelerating deuterium ions from a plasma source, inducing magnetic gradient forcing of the ions thereby accelerating the ions to an energy level required for neutron spallation, and allowing the released neutrons to interact with a fuel thus causing an isotope shift of said fuel.

The magnetic gradient wave-forcing of the ions may be achieved by means of an induction coil, an electric spark arrangement or a plurality of capacitive coupled electric field plates in the ion accelerator.

According to a fifth aspect, a method for providing neutron spallation is provided. The method comprises pre-accelerating ions from a plasma source (200), and inducing magnetic gradient wave-forcing of the ions thereby accelerating the ions to an energy level required for neutron spallation.

In an embodiment the magnetic gradient wave-forcing of the ions is achieved by means of an induction coil arranged around a housing of an ion accelerator.

In an embodiment the magnetic gradient wave-forcing of the ions is achieved by means of an electric spark arrangement, or a plurality of capacitive coupled electric field plates inside the ion accelerator housing.

### BRIEF DESCRIPTION OF THE DRAWINGS

With reference to the appended drawings, below follows a more detailed description of embodiments of the invention cited as examples. In the drawings:

FIG. 1 is an illustration of the four ponderomotive force effects induced by transverse alternating electric fields in magnetized plasma;

FIG. 2a is a diagram showing successive neutron captures by chlorine to isotope and element transmutations;

FIG. 2b is a diagram showing a sequence of thermal neutron capture transmutations for nickel and cobalt;

FIG. 3a is a schematic view of an accelerator, i.e. a spallator producing the required neutrons for the neutron capture reactor according to an embodiment, implementing combined primary electrostatic ion acceleration and wave MG ion acceleration in a diverging dipole-like magnetic field, of which wave power originates from an exterior coil;

FIG. 3b is a detailed view of a plasma source and primary ion accelerator of the neutron spallator shown in FIG. 3a;

FIG. 4a is a schematic view of an accelerator/spallator producing the required neutrons for the neutron capture reactor according to an embodiment, implementing combined primary electrostatic ion acceleration and wave MG ion acceleration in a diverging dipole-like magnetic field, of which electrostatic wave power is produced by controlled discharges in front of the combined magnet ion accelerator;

FIG. 4b is a detailed view of a plasma source and primary ion accelerator of the neutron spallator shown in FIG. 4a;

FIG. 4c is a close-up view of the magnet and an Ignition Coil Generator (ICG) discharge unit of the neutron spallator shown in FIG. 4a;

FIG. 5 is a schematic view of an accelerator/spallator according to an embodiment, more specifically a dual/twin arrangement based on the spallator shown in FIG. 3a;

FIG. 6 is a schematic view of an accelerator/spallator according to an embodiment, more specifically a dual/twin arrangement based on the spallator shown in FIG. 4a;

FIG. 7 is a schematic view of an accelerator/spallator according to a yet further embodiment, for electrostatic wave acceleration;

FIG. 8 is showing two diagrams showing the magnetic gradient wave-force vs wave frequency;

FIGS. 9a-b show two diagrams illustrating simulations of deuterium ion acceleration versus distance in a dual magnetic bottle accelerator with length as described with reference to FIG. 6;

FIG. 9c is a diagram showing simulation results of a deuterium-chlorine reactor based on the concepts shown in FIGS. 8 and 9a-b;

FIG. 10a is a longitudinal cross-sectional view of a power generator using the reactor shown in FIG. 6;

FIG. 10b is a transversal cross-sectional view of a power generator using the reactor shown in FIG. 6;

FIG. 11a is a longitudinal cross-sectional view of a power generator according to an embodiment, based on FIG. 5;

FIG. 11b is a transversal cross-sectional view of the power generator shown in FIG. 11a;

FIG. 12a is a longitudinal cross-sectional view of a power generator according to an embodiment, based on FIG. 6;

FIG. 12b is a transversal cross-sectional view of the power generator shown in FIG. 12a;

FIG. 13a is a longitudinal cross-sectional view of a generator assembly according to an embodiment, based on FIG. 11a;

FIG. 13b is a transversal cross-sectional view of the generator assembly shown in FIG. 13a;

FIG. 14a is a longitudinal cross-sectional view of a generator assembly according to an embodiment, based on FIG. 7;

FIG. 14b is a transversal cross-sectional view of the generator assembly shown in FIG. 14a

FIG. 15a is a longitudinal cross-sectional view of a generator assembly according to an embodiment, based on FIG. 7;

FIG. 15b is a transversal cross-sectional view of the generator assembly shown in FIG. 15a;

FIG. 16a is a longitudinal cross-sectional view of a generator assembly according to an embodiment, based on FIG. 7;

FIG. 16b is a transversal cross-sectional view of the generator assembly shown in FIG. 16a; and

FIG. 17 is a schematic view of a method according to an embodiment.

### DETAILED DESCRIPTION

Before turning to details of the power generator and various embodiments thereof some general comments on the physics involved will be given, especially with regards to plasma and ion acceleration.

Various processes govern ion acceleration in plasma, by static and/or induced electric fields and/or by electromagnetic or electrostatic waves. These processes have particular consequences for magnetized plasmas in space as well as in the laboratory. Fully magnetized plasmas implies that the magnetic field is in spatial control of the plasma, charged particles gyrating perpendicular to the magnetic field, clock-wise or anti-clock-wise depending on electric charge. While the magnetic field provides spatial control in the direction being perpendicular to the magnetic field, plasma may run away more easily in the direction parallel to the magnetic field. This is particularly important if the magnetic field weakens in the magnetic field-aligned direction, such as in a dipole magnetic field. In this case the particle gyro-motion will facilitate a run away, gradually converting transverse/gyration energy to parallel and field aligned energy—maintaining conservation of energy (first adiabatic invariant).

Converting transverse/gyro-energy to magnetic field aligned focused energy, being the first basic principle used by the reactors described herein for producing free neutrons, implies no gain of ion energy. To gain net energy acceleration processes are required, such as field aligned electrostatic acceleration and/or electromagnetic/electrostatic wave acceleration. Embodiments of the ion accelerating devices forming part of the power generators described in this application rely on both, but as will be understood wave acceleration will play the major role in powering and controlling the spallation process.

Wave acceleration may be described by a concept denoted “ponderomotive forcing”, and could be implemented by a concept originally denoted Magnetic Moment Pumping as presented by the inventor already in Geopys. Res., 94, 6665, 1989. The equations used here originates from a review article by the inventor and a colleague in Space Sci. Rev., DOI 10.1007/s11214-006-8314-8, 2006.

The force, induced by electromagnetic or electrostatic waves, is field-aligned and unidirectional towards the weakening part of a diverging magnetic field. It is therefore more appropriate to here use the notion Magnetic Gradient (MG) wave-forcing, because wave ponderomotive forcing is associated with temporal (wave) and spatial (field and matter) gradients.

The magnitude of the MG wave-force depends on the magnitude of the wave electric field and the magnetic field divergence, the force always pointing in the direction of the weakening magnetic field regardless of the propagation direction of the electromagnetic/electrostatic wave.

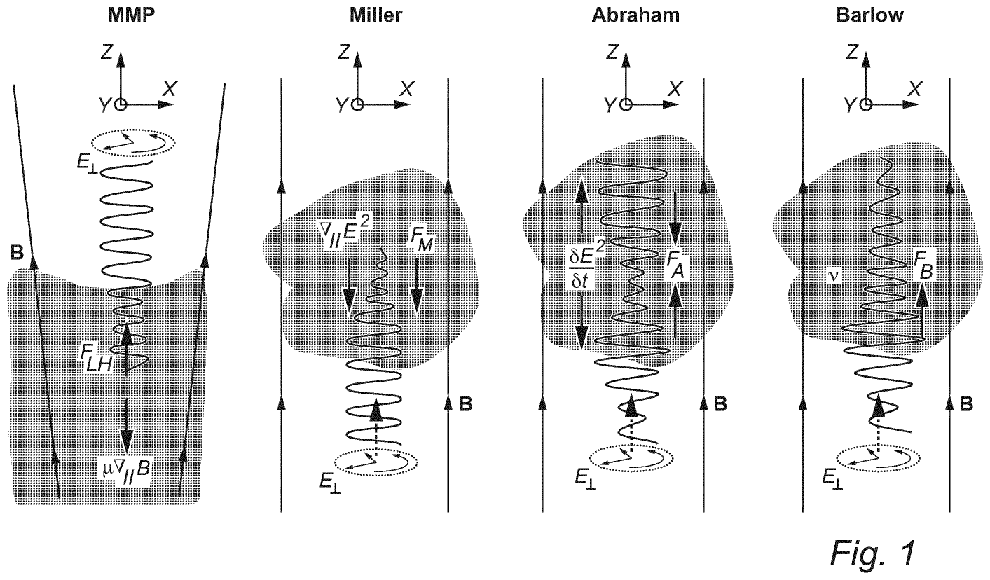

Generally speaking, all types of ponderomotive forces may operate simultaneously. In FIG. 1, an illustration of four ponderomotive force effects induced by transverse alternating electric fields in magnetized plasma is shown. Each of the four types can be further subdivided depending on the wave mode, region of application, etc. In summary, the individual equations for the MG/MMP, Miller, Abraham and Barlow forces lead to the following expression for the total field-aligned ponderomotive force, in cgs units, by traveling Alfvén waves well below gyro-resonance:

$${F}_{\vert \vert} = - \frac{m {c}^{2}}{2 {B}^{2}} [ \frac{{E}^{2}}{B} \frac{\partial B}{\partial z} - \frac{1}{2} \frac{\partial {E}^{2}}{\partial z} ∓ \frac{1}{{c}_{A}} ( \frac{\partial }{\partial t} + v ) {E}^{2} ] \qquad ( Eq . 1 )$$

Of the four potential ponderomotive effects on plasma, as described in FIG. 1 and equation 1, the MG/MMP force is the most powerful one in strongly magnetized plasmas with strong spatial/temporal magnetic gradients. As for the Barlow force the viscous (frictional) term may also constitute plasma wave turbulence. If so, powerful plasma wave turbulence may lead to besides strong Barlow force acceleration, also a cross-field diffusion of plasma in the magnetic field. In what follows a brief description and motivation of the Gradient/Miller force, the MG/MMP force, and the Barlow force will be given, together with an assessment and quantitative analysis of their applicability in the acceleration of deuterium ions up to spallation energy (2.25 MeV).

The fact that waves primarily propagates along magnetic field lines, implies that MG/MMP and Barlow forces are good candidates for ion acceleration. This reduces the treatment to the following two equations for wave frequencies ω.

$${F}_{z} = - ( \frac{{e}^{2} {E}^{2} Ω}{2 {m ( {ω}^{2} - {Ω}^{2} )}^{2}} \frac{\partial Ω}{\partial z} \pm \frac{{vmc}_{A}}{2} {( \frac{{b}_{0}}{B} )}^{2} Φ ( \frac{ω}{Ω} ) ) \qquad ( Eq . 2 )$$

In equation (2), the first term on the right-hand side represents the MG wave-force, and the second term the Barlow force. Ω is the ion cyclotron (resonance) frequency, v the collision frequency, b₀ the magnetic component of the electromagnetic wave, C_{A} the Alfvén velocity, B the ambient magnetic field and Φ(ω/Ω) is a term describing the relation between ω/Ω and Ω/v. Notice from equations (1) and (2) that the MG force is unidirectional regardless of wave frequency, i.e. pointing in the direction (z) of the weakening magnetic field.

For ion cyclotron waves the following expression for the MG force holds

$${F}_{z} = - \frac{{e}^{2} {E}^{2}}{2 m {ω ( ω - Ω )}^{2}} \frac{\partial Ω}{\partial z} . \qquad ( Eq . 3 )$$

While the MG force expression for linearly polarized Alfvén waves is

$${F}_{z} = - \frac{{e}^{2} {E}^{2} Ω}{2 {m ( {ω}^{2} - {Ω}^{2} )}^{2}} \frac{\partial Ω}{\partial z} \qquad ( Eq . 4 )$$

The main difference between the expression for ion cyclotron wave (Eq. 3) and Alfvén waves (Eq. 4) is that the former force (F_{z}) besides having a maximum at the singularity (ω=Ω) also increases towards low frequencies. From equation (3), we may now derive another expression that relates to the MG velocity versus z for ion-cyclotron waves with electric field E:

$$V ( z ) = \frac{c E}{\sqrt{2} {B}_{0}} {\{ {[ \frac{{B}_{0}}{B ( z )} ]}^{2} - 1 \}}^{1 / 2} . \qquad ( Eq . 5 )$$

Where E≈(P_{W})^{1/2} and P_{W} now corresponds to electrostatic wave power. Equation (5) describes the governing terms involved in the wave electric field E acceleration of ions in a diverging magnetic field (B₀/B(z)).

Equation (5) demonstrates that for a given wave electric field, a magnetic field divergence (B₀/B(z)) increase by a factor of ≈10 leads to a field-aligned ion velocity ten times the initial (E/B₀) velocity at z=z₀, provided E/B₀ stays fixed along z.

Using equation (5) it is also possible to derive a similar expression for W(z), the energy for ions with mass m versus z:

$$W ( z ) = \frac{m {c}^{2}}{4} {( \frac{E}{{B}_{0}} )}^{2} \{ {[ \frac{{B}_{0}}{B ( z )} ]}^{2} - 1 \} . \qquad ( Eq . 6 )$$

While the Equations (5) and (6) applies for momentary acceleration (predetermined by E/B₀) one may in addition infer an expression for stochastic broad-band electric field oscillations that involves “local” resonance ω=Ω(z) at any point in the course of the ion motion along a diverging magnetic field flux tube, where Ω is the ion gyro frequency along the diverging magnetic field.

A further development, but now based on resonance induced by stochastic broad-band electric field oscillations, is thereby that ions may “see” resonant oscillations with ω=Ω(z). The general MG forcing term of a steady stochastic process, denoted permanent MG resonance, leads the following expression for the energy gain of the parallel ion motion:

$$Δ {W}_{\vert \vert} \approx \frac{{e}^{2}}{m} {\int }_{0}^{z} \frac{{E}_{Ω}^{2}}{B ( z )} \vert \frac{\partial B}{\partial z} \vert dz \qquad ( Eq . 7 )$$

A permanent MG wave-resonance therefore implies additional parallel acceleration ΔW_{||} of ions along the central axis of the magnetic field divergence.

The Miller/Gradient force may also play an important role. Depending on the wave frequency ω the gradient force may change acceleration direction. The following expression applies for the longitudinal (along z) gradient force (in cgs units) governed by Alfvén waves in a fluid:

$${F}_{Z} = - \frac{{e}^{2}}{4 m ( {ω}^{2} - {Ω}^{2} )} \frac{\partial {E}^{2}}{\partial z} \qquad ( Eq . 8 )$$

Where ∂E²/∂z, the spatial gradient of the wave electric field, determines the magnitude of the force, and Ω is the ion cyclotron (resonance) frequency. Notice that the gradient force like the MG force has a singularity at ω=Ω. However, the gradient force changes sign/direction in the singularity, the gradient force being attractive for ω<Ω and repulsive for ω>Ω. The implication of this is that low-frequency Alfvén waves (ω<Ω) attract charged particles towards the wave source, while high-frequency Alfvén waves repel particles. In the low-frequency case, ω²<<Ω², using Ω=eB/mc we obtain from equation (8):

$${F}_{z} = \frac{m {c}^{2}}{2 {B}^{2}} \frac{\partial {E}^{2}}{\partial z} \qquad ( Eq . 9 )$$

Equation (9) implies that the force is constant and independent of wave frequency in a homogeneous medium (B=constant) at very low frequencies, the force being proportional to the gradient and magnitude of the electromagnetic wave intensity (∂E²/∂z). The decreasing/damped wave intensity in the course of the interaction (exerting force on matter) implies a force F_{z} directed opposite to the wave propagation direction, i.e. causing an attraction of matter towards the wave source. The latter makes it important to consider effects related with gradient forcing in context with excess heat production.

The Miller force will in fact play a major role in one of the embodiments to be described—as a means to stimulate controlled chain reactions.

### Ion Acceleration, Neutron Spallation and its Context with Neutron Capture

The enabling process for Neutron Spallation and Neutron Capture (from hereon denoted NSNC) is neutron spallation, for deuterium (²H⁺) requiring an input of 2.25 MeV to overcome the neutron binding energy. Preference is here on electrostatic waves generated by square-wave electric fields via capacitive coupled electric field plates. The wave electric field component, directed perpendicular to the magnetic field, is preferably due to ponderomotive MG wave forcing. However, as will be explained in this specification, electromagnetic wave induction via coils is also feasible, in particular for solid-state NSNC reactors. Notice that electrostatic waves enable both the non-resonant (equation (4) and (5)), and the stochastic resonant (equation (6)) solutions. The gradual acceleration of ²H⁺ up to spallation energy of 2.25 MeV is a necessary, but not sufficient condition unless the ²H⁺ kinetic energy via e.g. impact is converted to H⁺+n.

Ponderomotive effects and wave acceleration is applicable on laboratory as well as on space plasmas. Common for all embodiments of the power generator described in the following is that it comprises a small-scale accelerator in moderate, yet controlled vacuum using ponderomotive wave forcing of deuterium ions up to the required spallation energy of 2.25 MeV where thermal neutrons can be released. Notice, however, that acceleration of deuterium ions up spallation energy 2.25 MeV does not necessarily imply spallation per se. Kinetic energy is a necessary, but not sufficient criteria unless promoted by e.g. collisions. Releasing a neutron from deuterium is an intrinsic spallation process requiring 2.25 MeV. Now, following neutron spallation the capturing of neutrons by suitable nuclides/isotopes will release energy in excess of the spallation energy.

The art of energy/power production from neutron capture depends on the state of the elements involved—solid, fluid, gas, or plasma, but also on the concepts used to connect the neutron production with neutron capture. The art promoted here is that neutrons are mainly (but not necessarily) produced in plasma state, while energy production by neutron capture is feasible in all states. Eventually, the high temperature produced by neutron capture may transfer a solid “fuel” to fluid and/or gas, enhancing the pressure inside a reaction container. Regardless of operational states, the neutron capture reaction container must be able to sustain a wide temperature and pressure range, and enable heat exchange to external systems for e.g. electric power production.

Regarding the reaction container, high mass metallic elements should be avoided for the following two reasons:

(1) neutron capture of high mass elements may lead to long-lived radioactive waste.
(2) neutron capture of high-mass metallic elements with high neutron capture coefficients, leads to low, or negative yield. With one exception the hardware in all reactors described herein contain aluminum, aluminum oxide, titanium and a small amount of copper, stainless steel (cover), and neodymium (for the magnets).

Considering that the NSNC process is a “natural” transmutation process, it should occur whenever and wherever there are free neutrons, released by neutron spallation. Local changes of the deuterium abundance versus hydrogen and the corresponding local changes in isotopic composition may be considered the “smoking gun” of the NSNC process. Low deuterium abundance implies spallation and isotope transmutations in the past. Conversely, high deuterium abundance implies minor deuterium spallation and isotope transmutations.

Table 1 display some characteristic data for elements involved in neutron spallation and neutron capture, such as binding energies, spallation energies of neutrons, neutron capture coefficients (σ), energy gain from neutron capture (ΔE), and the energy gain with respect to the energy input required for neutron spallation. Notice that ³⁵Cl has the highest neutron capture return of the five elements in the table. Incidentally, chlorine is an abundant element in Earth's seawater. Together with the availability of deuterium in seawater (0.015%), makes the combination deuterium and chlorine a powerful and sustainable terrestrial energy source.

TABLE 1
Neutron Spallation (NS) of ²H, and examples of thermal neutron capture by
heavier elements and their corresponding energy gain from neutron capture.

| | | | | | | | | Deuterium spallation | | |
|---|---|---|---|---|---|---|---|---|---|---|
| | | | | Bind. E. | [symbol] | ΔE | n-in/ | D input | Output | Gain |
| Isotope | Abundance % | p | n | (MeV) | n-capt. | (MeV) | capt. | (MeV) | (MeV) | ratio |
| H | 99.985 | 1 | 0 | 0 | | −2.245 | 1 | | | |
| ²H | 0.015 | 1 | 1 | 2.245 | | 0 | | | | |
| [symbol] Cl | 75.8 | 17 | 18 | 288.82 | 43.60 | 0 | | | | |
| [symbol] Cl | — | 17 | 19 | 306.792 | 10.00 | 17.57 | 1 | −2.25 | 15.73 | 8.01 |
| [symbol] Cl | 24.2 | 17 | 20 | 317.09 | 0.43 | 28.27 | 2 | −4.49 | 23.78 | 6.30 |
| [symbol] Ti | 73.7 | 22 | 25 | 418.698 | 8.30 | 0.00 | | | | |
| [symbol] Ti | 5.2 | 22 | 26 | 437.780 | 0.18 | 19.08 | 2 | −4.49 | 14.59 | 4.25 |
| [symbol] Co | 100 | 27 | 32 | 517.312 | 74.00 | 0.00 | | | | |
| [symbol] Co | — | 27 | 33 | 524.808 | 2.00 | 7.50 | 1 | −2.25 | 5.75 | 3.34 |
| [symbol] Cr | 83.9 | 24 | 28 | 456.352 | 0.86 | 0.00 | | | | |
| [symbol] Cr | 9.5 | 24 | 29 | 464.291 | 18.6 | 7.94 | 1 | −2.25 | 5.69 | 3.54 |
| [symbol] Cr [symbol] | 2.4 | 24 | 30 | 474.007 | 0.41 | 9.72 | 1 | −2.25 | 7.47 | 4.33 |
| [symbol] Ni | 68.1 | 28 | 30 | 506.460 | 4.37 | 0.00 | | | | |
| [symbol] Ni | — | 28 | 31 | 515.454 | 77.70 | 8.99 | 1 | −2.25 | 6.75 | 4.01 |
| [symbol] Ni | 26.2 | 28 | 32 | 526.850 | 2.50 | 20.39 | 2 | −4.49 | 15.90 | 4.54 |
| [symbol] Ni | 1.1 | 28 | 33 | 534.660 | 2.10 | 28.20 | 3 | −6.74 | 21.47 | 4.19 |
| [symbol] Ni | 3.6 | 28 | 34 | 545.258 | 14.90 | 38.80 | 4 | −8.98 | 29.82 | 4.32 |
| [symbol] Ni | — | 28 | 35 | 552.100 | 24.40 | 45.64 | 5 | −11.23 | 34.42 | 4.07 |
| [symbol] Ni | 0.9 | 28 | 36 | 567.754 | 1.64 | 55.29 | 6 | −13.47 | 41.82 | 4.10 |

[symbol]

indicates data missing or illegible when filed

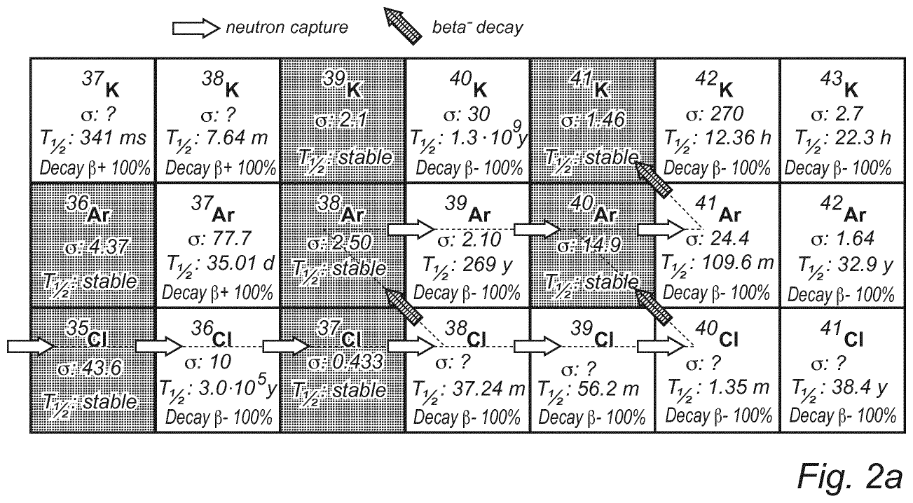

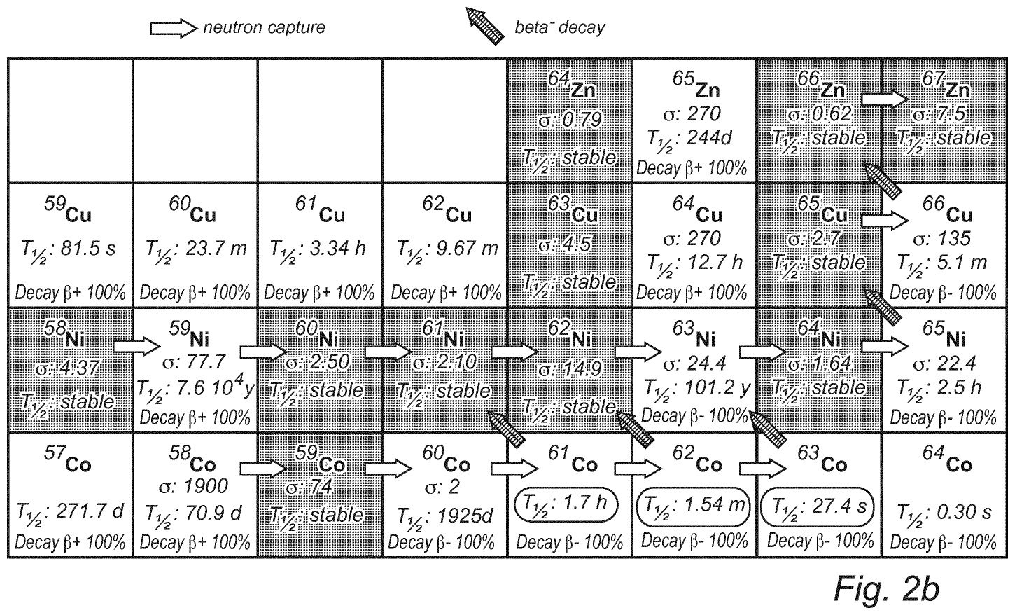

FIG. 2a is showing a sequence of successive transmutations associated with neutron capture of ³⁵Cl. Notice that besides isotope transmutations, e.g. ³⁵Cl →³⁶Cl, element transmutation are also feasible. Eventually, following five/six neutron captures and two β³¹ decays, the stable ³⁵Cl element via β⁻ decays may be transmuted to the stable ³⁸Ar, and ⁴⁰Ar, and eventually also to the stable ⁴¹K. The chain-of-events illustrates that excess argon outflow during events related with geological activity may be associated with internal NSNC processes associated with chlorine transmutations.

FIG. 2b illustrates a “natural” sequence of thermal neutron capture transmutations for nickel, and cobalt. The sequence is initiated by neutron capture of ⁵⁸Ni and/or ⁵⁹Co, followed by isotope transmutations of nickel and cobalt up to their corresponding unstable isotopes, whereby element transmutations via β⁻ decay eventually takes place. Alternatively the transmutation continues to the next unstable isotope etc. The speed and efficiency of the isotope and element meandering is determined by their corresponding neutron capture coefficient (σ). The high σ of ⁵⁹Co suggests that cobalt offers the “fastest” transmutations path to ⁶⁷Zn. Hence the sequence ⁵⁹Co—⁶⁰Co—⁶¹Co—⁶²Co is a fast path to ⁶²Ni and further on if ⁵⁹Co (high σ) is the main fuel.

The selection of isotopes and elements displayed in Table 2 show binding energies, neutron spallation energies (²H, ⁷Li), and neutron capture coefficients (σ).

Three neutron capture elements are considered; chlorine, titanium and nickel. The table display output energies and energy gains from neutron capture, the energy gain defined as the ratio between the net output energy and the input/spallation energy. A comparison between the spallation of deuterium and lithium clearly indicates the advent of deuterium spallation, a factor of three higher gain for deuterium compared to lithium.

### The Ponderomotive Wave Ion Accelerator and Neutron Spallator

As will be explained embodiments of the power generator comprises an ion accelerator being operable in moderate vacuum (such as in the range of 1-10⁻⁴ mbar), and forming a device capable of accelerating ions up to MeV energies over short distances, such as less than 50 cm. A two-stage acceleration process enables full control of the ion beam intensity and energy for optimal neutron capture performance.

The ion accelerator of the power generator is preferably configured to accelerate deuterium ions up to spallation energy, 2.25 MeV, whereby neutrons are released and deuterium is transmuted to hydrogen. Secondly, combined with neutron capture of suitable isotopes/nuclides the invention enables the production of energy, promoting further neutron spallation via a controllable chain-reaction.

Equations (1-9) described above offers the theoretical framework for ion acceleration based on electromagnetic, and electrostatic wave ponderomotive forcing. Although all expressions may be partially involved, focus will be on the most powerful one MG wave-forcing, a power generator based on the diverging (dipole-like) magnetic field from strong magnets. Contemporary Nd-Fe magnets may easily reach one Tesla, implying that it is possible to obtain a ratio to ambient magnetic fields (e.g. Earth's dipole field) of at least three orders of magnitudes. From equation (5) it is possible to obtain a velocity amplification of 1000 from the convective term E/B. In a similar manner, from equation (6) it is possible to obtain an energy amplification W(z) of 10⁶, i.e. well in the MeV range. Therefore, with adequate wave electric power (E) properly applied to induce ion cyclotron waves in a diverging magnetic field, MeV ions can be readily produced in a suitably sized MG wave-accelerator part of a power generator (i.e. less than 1 m).

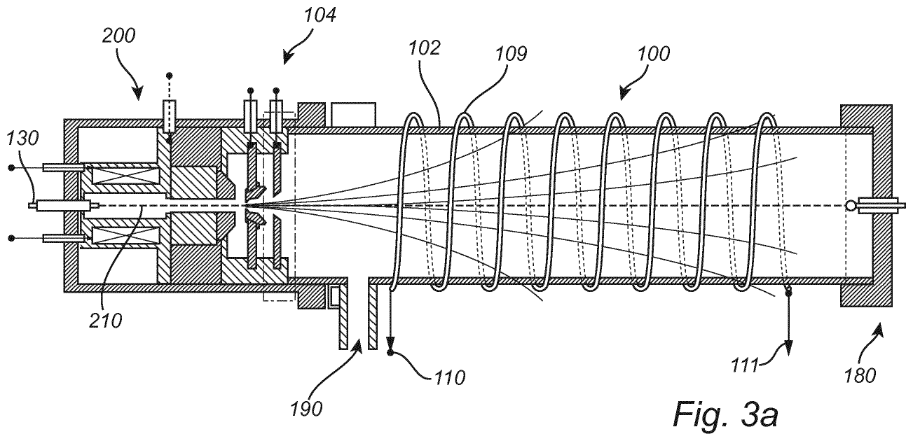

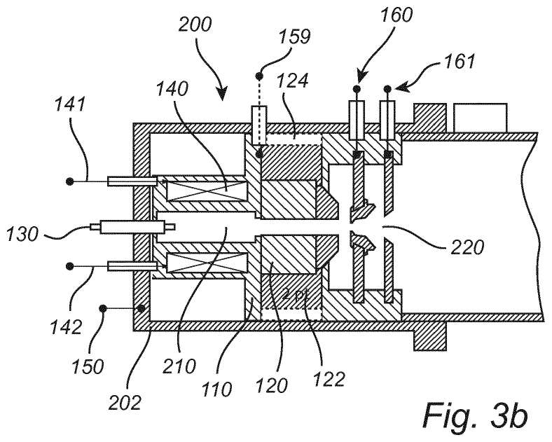

FIGS. 3a-b and 4a-c show in cross-section the enabling elements, the accelerator/spallator in the neutron capture power generator. The MG wave-accelerator 100 comprises a ceramic (or glass) housing 102 forming the acceleration path of ions. At one end 104 a separate plasma source and ion pre-accelerator unit 200 is attached to the MG wave-accelerator 100. The entire system is attached to a vacuum pump 190, and to a deuterium gas inlet 130 feeding the deuterium gas into the ionization chamber 210. MG wave acceleration is here provided by an induction coil 109, powered by high-frequency electromagnetic square-waves via connectors 110 and 111. Ponderomotive ion MG wave-acceleration is the main enabling process for neutron production, neutron capture and isotope transmutations, i.e. the two-stage Neutron Spallation and Neutron Capture process. Waves produced by the induction coil 109 also serve the purpose of homogenizing, and controlling ion energization in the accelerator 100. An end flange 180 is closing the opposite end of the cylinder 102.

In FIG. 3b further details of the plasma source and ion pre-accelerator unit 200 of the ion MG wave-accelerator 100 are shown. The pre-accelerator unit 200 has a metal housing 202 enclosing various components as will be described in the following, as well as being used for connecting the pre-accelerator unit 200 to the cylinder 102 of the accelerator 100.

The deuterium plasma, generated from deuterium gas fed via 130 into the ionization chamber 210, is generated by high frequency induction via a coil 140 externally connected via electrical connectors 141 and 142. The coil 140 is preferably embedded in a ceramic insulator 204. The main volume of the inner section of the pre-accelerator unit 200 consists of insulating ceramics 124 for electrical shielding of a cylindrical magnet 120 and an aluminum magnet holder 122. Between the housing 202 and the aluminum holder 122 a ceramic cylinder 124 may be placed to allow for positive charging of the magnet plus frames 159. The magnet 120 may preferably reach a magnetic field magnitude of up to 1 Tesla. Because the plasma in the front end of the ionization chamber 210 is charged up to kilovolt potentials by means of an electrode 160 operating as an anode in negative high voltage mode and as a cathode in positive high voltage mode, while the aperture and housing is on ground/return potential 150, ions will be extracted and pre-accelerated up to kilovolt energies via the aperture 220 into the accelerator 100. A ion beam shaper 161 is arranged around the aperture 220.

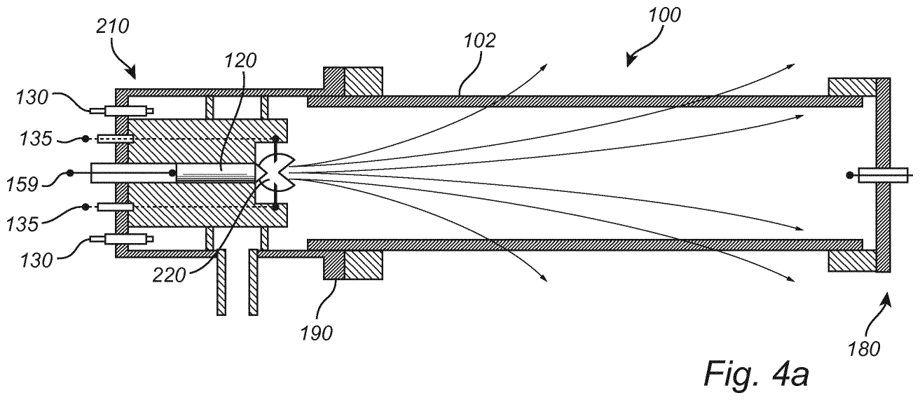

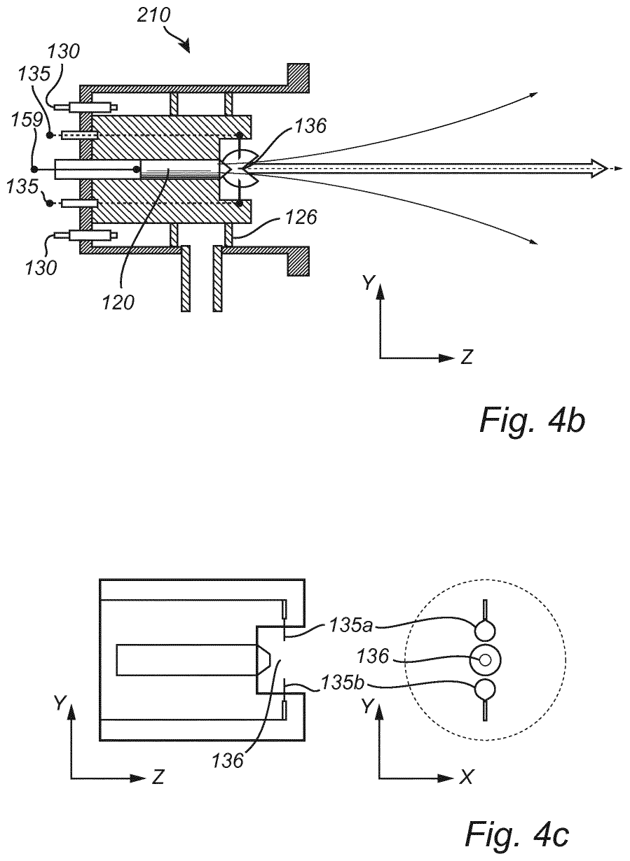

FIG. 4a shows in cross-section the enabling elements in a neutron capture power generator using an alternative pre-accelerator. The MG wave-accelerator 210 comprises a ceramic (or steel) housing 102 forming the acceleration path of ions. The difference compared to FIG. 3a is that ionization is governed by Ignition-Coil-Generator (ICG) 135 discharges in front of the magnet 120. The ICG frequency-controlled discharges provide electrostatic waves required for MG wave-acceleration, eliminating the need for alternative means for ionization and generation of electrostatic waves. Another difference compared to the embodiment shown in FIG. 3a is a slimmer and more straight magnet. Lacking a central hole implies lower beam-spread, less power losses, and less ion beam interference. An additional gas inlet 130 for multipurpose use is introduced. The entire system is attached to a vacuum pump 190, and to the deuterium gas inlet 130 feeding the deuterium gas into the pre-acceleration chamber 210. Because the novel pre-accelerator allows for neutron capture inside the cylinder, the reactor cylinder will be made of stainless steel to sustain the interior pressure and temperature inside a power generator.

FIG. 4b show details of the ion pre-accelerator unit 210 of the ion MG wave-accelerator 100. The main difference compared to the embodiment shown in FIG. 3b is that in FIG. 4b a more straightforward method for generating plasma and electrostatic waves acceleration at kilovolt potentials is offered. Beam-shaping is governed by a “natural” process, wave-driven plasma extraction providing a cavity that may lead to further beam focusing. As can be seen in FIG. 4b the magnet 120 is mounted by means of a vented support 126, and the discharges will occur at the gap 136 in front of the magnet 120.

FIG. 4c shows a close-up view of the magnet 120 and ICG set-up; the ICG is provided with rounded electrodes 135a-b used to smooth and spread the discharges at the gap 136.

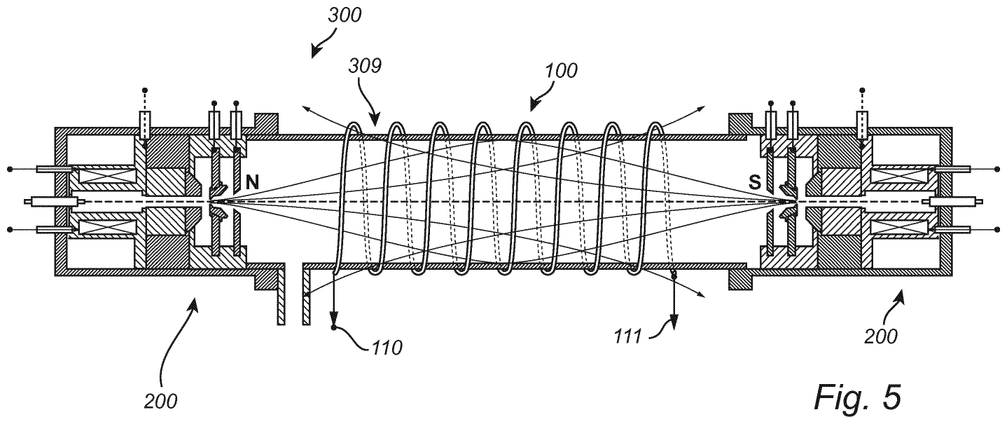

A dual MG ion accelerator 300 with a combined north (N) a south (S) pole magnetic field, based on the same principles as in FIGS. 3a-b is displayed in FIG. 5. The configuration creates a “magnetic bottle” with the strongest magnetic field near the ion pre-accelerator aperture 165 and the weakest magnetic field in the center. Considering the magnetic field divergence in the magnetic bottle (see e.g. equations 5-8), the central region is therefore the site of maximum/peak energy for ions emerging from both (N and S) sides—i.e. the region where neutron spallation may take place. Most important, with beams coming from opposite directions it marks the joint “target zone” for neutron spallation, and break in contact between ions/plasma from the “other” side. As major zone of neutron production the central region may therefore also be described as the “interaction zone”, a potential site for neutron capture.

The exterior heating and ionization induction coil 309, with connectors 110-111 is therefore also in this embodiment an additional item that relates to the neutron capture and isotope transmutation process, i.e. the second part of the two-stage NSNC process. Again, the induction coil 309 enables control of the acceleration process in the ion accelerator/reactor 300.

As is shown in FIG. 5 each end of the ion accelerator 300 is provided with a plasma and ion source being identical to the source 200 described with reference to FIGS. 3a and 3b.

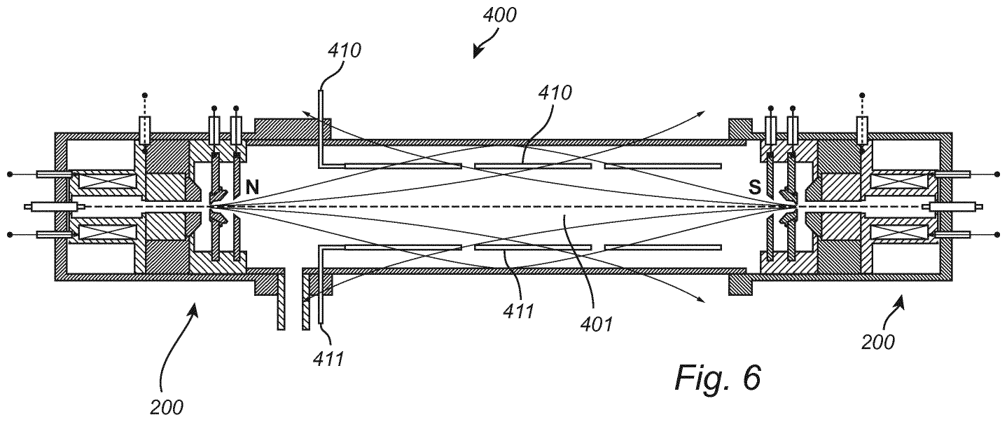

A principal diagram of another, more efficient dual magnetic bottle ion accelerator 400 using “capacitive” coupled electric field plates 410-411 arranged inside the ion accelerator housing is shown in FIG. 6. It should however be understood that in some embodiments the electric field plates 410, 411 are instead arranged on the outside of the housing, preferably in direct contact with the outer wall of the accelerator 400.

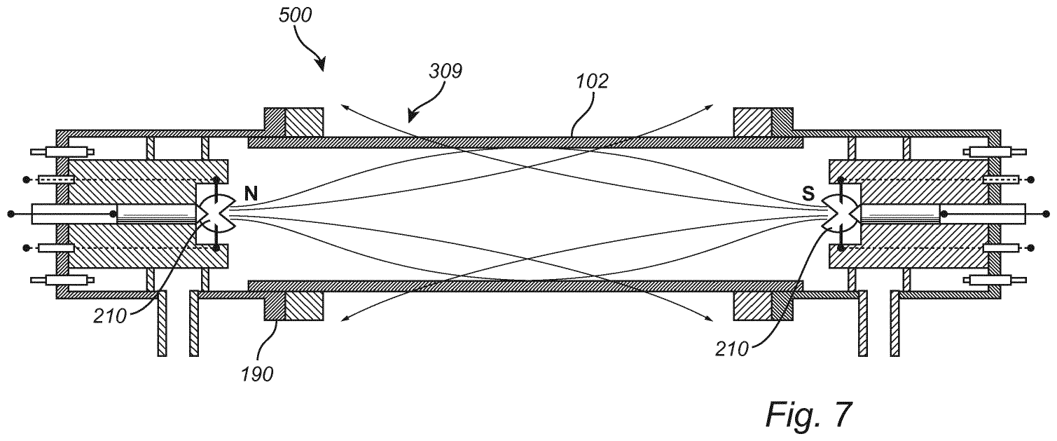

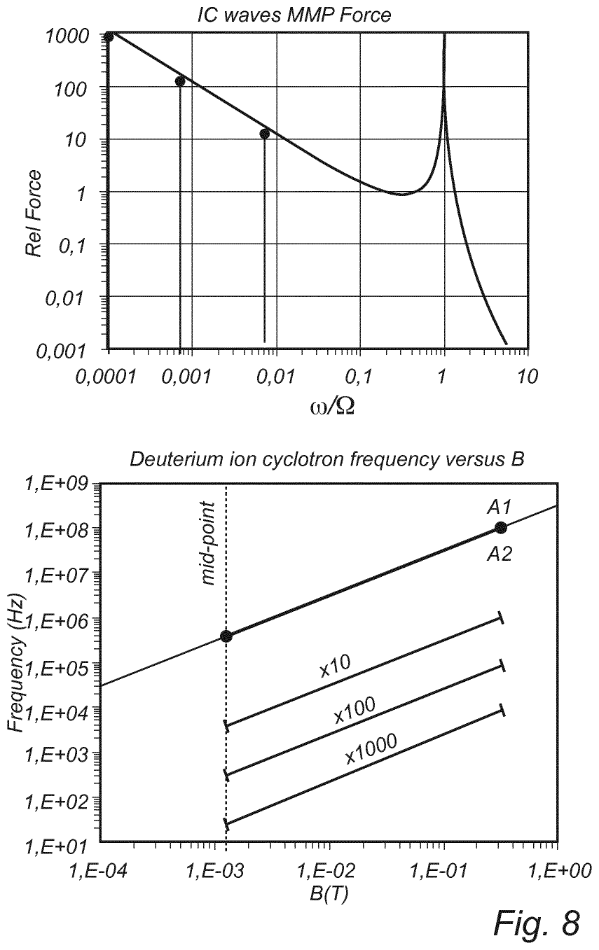

Instead of using capacitive coupled electric field plates, controlled anode-cathode high-voltage discharges from an ICG may be used to generate electrostatic waves as shown in FIG. 7. Both alternatives offers improved efficiency, i.e. less waste of input power compared to that using an induction coil. Most of the pulsed electric field wave power, acting perpendicular to the magnetic field, now goes to ion acceleration (equations 5-8). This acceleration option, denoted electrostatic wave MG wave-forcing, is also a concept enabling alternative acceleration options. For instance, by producing ion-cyclotron waves (ICW) MG wave-forcing is less dependent on resonance. The MG wave-force for ICW now increases towards low frequencies (as is shown in FIG. 8). Another option is that fast-switching of electric field pulses produces a broad-band high-frequency wave spectrum, encompassing resonance over a suitable range of frequencies fostering ion acceleration as suggested by equation (7). Also in this embodiment, each end of the ion accelerator 400 comprises a plasma source and pre-accelerator 200.

FIG. 8 displays a graph illustrating the MG force versus normalized (to resonance) Ion Cyclotron (IC) wave frequency. The upper diagram illustrates the MG wave-force versus normalized (to resonance) Ion Cyclotron (IC) wave frequency, and the lower diagram the deuterium resonance frequency versus magnetic field in typical reactor deuterium plasma (10% ionization) at 10⁻² mbar (upper thick solid curve). The thinner slanted lines demonstrate that the acceleration force increases for low IC frequencies, a fact that facilitates powerful ion acceleration at low frequencies.

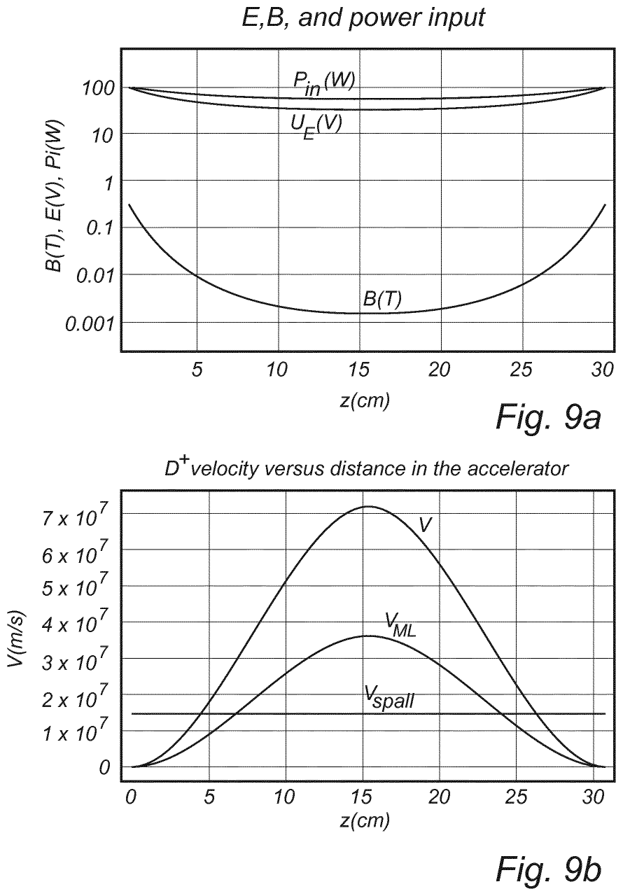

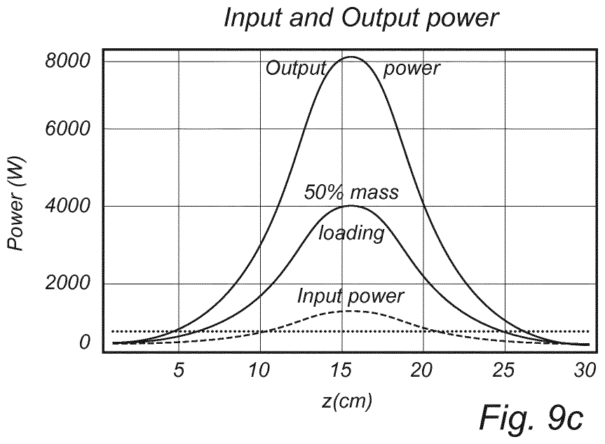

Reactors and ion accelerators in accordance with the above description have undergone theoretical simulations and various tests, the former illustrated by FIGS. 9a-b. The length of the reactor used in the simulations is 30 cm. The diagram of FIG. 9a is showing input values of the magnetic field strength, voltage pulses and the corresponding power input, while the diagram of FIG. 9b is showing the velocity of the deuterium ions, as well as the velocity level required for spallation (straight line in FIG. 9b). Notice that the simulated ion peak velocity is significantly above the required spallation velocity level, indicating at least theoretically some margin to reach spallation energy.

Simulation results of a neutron capture reactor 400 in accordance with the embodiment shown in FIGS. 6 and 7 are displayed in FIGS. 9a-c. The reactor being provided with deuterium (for neutron spallation) and chlorine (for neutron capture) is providing excess output power. The bottom dashed curve is representing the wave E-field spallation power input dotted curve representing the average), the upper curves showing the output power from ³⁵Cl neutron-capture, without (upper curve) and with 50% mass-loading. The outset of the simulation is a reactor vacuum of 10⁻² mbar, high frequency square-wave electric field pulses with 125V amplitude, and a static magnetic field decaying from the anode accelerators by a factor of 190.

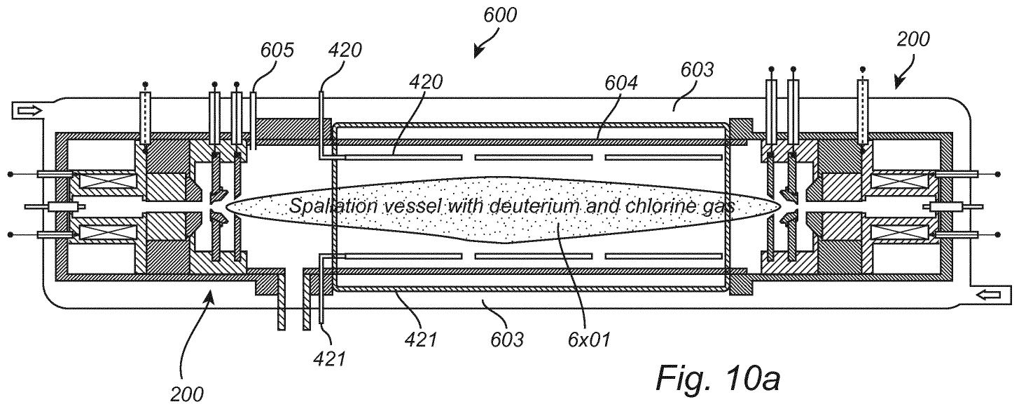

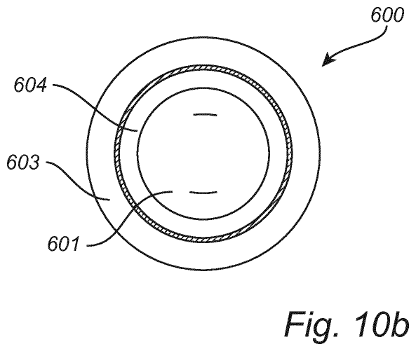

Again referring to FIGS. 6 and 10a-b, the reactor 400 comprises a central region that constitutes a potential collisional “interaction zone” for neutron spallation. Based on an internal gas pressure of 0.01 mbar in a test-reactor dedicated for neutron spallation only, a two-stream plasma interaction and direct collisional processes in the relatively dense plasma (≈10¹⁷ m⁻³) and neutral gas (≈10¹⁸ m⁻³), enable the production of neutron fluxes in the range 10¹³-10¹⁴ (neutrons/s).

Conversely, if the reaction chamber contains a suitable mix of deuterium and chlorine gas, neutron capture is expected to dominate where deuterium ions reaches spallation energy and neutrons are most abundant, i.e. in the reactor center. The local heat-production there may become self-perpetuating, i.e. Miller gradient forcing from thermal radiation may attract deuterium and chlorine gas towards a hot core, promoting further neutron spallation and neutron capture. Regardless of self-perpetuation, the yield from a deuterium-chlorine NSNC reactor is sufficiently high (≈8 times more output energy than input energy) to be considered a benchmark for further exploitation.

Both the capacitive coupled and controlled discharge method for electrostatic wave acceleration enable beside non-resonant also resonant acceleration. Non-resonant acceleration by ion-cyclotron waves (ICW) implies that the force for ICW increase towards low frequencies. Resonant forcing is enabled by broadband/stochastic waves generated by fast-switched electric field pulses. Broadband electric field waves enabling resonance over a suitable frequency range, promotes ion acceleration as inferred from equation (3).

Now continuing describing different embodiments of a power generator, reference is made to FIGS. 10-15. For all these embodiments, the power generator is based on the specific theoretical concept that enables deuterium ion acceleration and neutron spallation by ponderomotive forcing. The onset of neutron spallation, and subsequent neutron capture, requires an energy input to deuterium of at least 2.25 MeV. This can be achieved by energizing/accelerating deuterium ions up to spallation energy by wave ponderomotive forcing, specifically Magnetic Gradient (MG) wave-force as described above.

Two concepts for the power generator are considered:

(1) neutron spallation and neutron capture takes place in the same apparatus (FIGS. 10, 13, 15), or

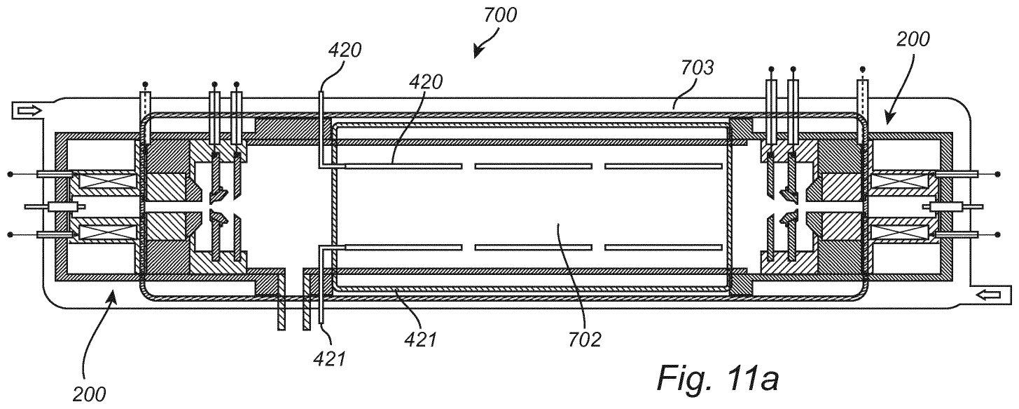

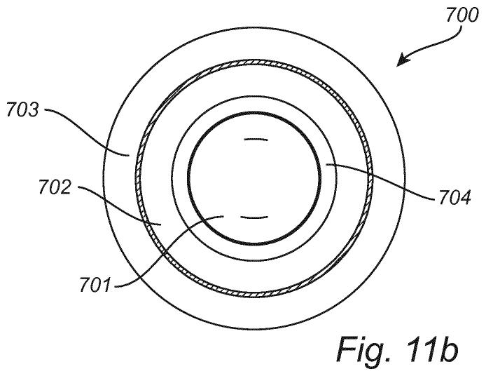

(2) neutron spallation is separated from neutron capture (FIGS. 11, 12, 14) whereby ion acceleration and neutron spallation is embedded in a central cylinder, while neutron capture and energy production takes place in an exterior cylinder. Regardless of concepts, energy/heat generated by neutron capture may be transferred to external power generators by water heat exchangers.

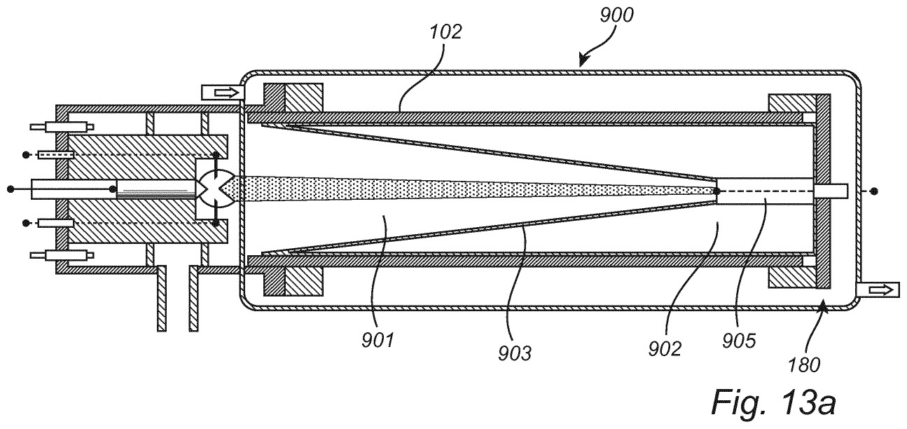

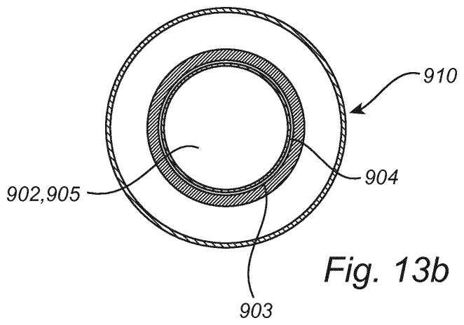

Option (1) enables controlled chain-reactions, i.e. the internal power from neutron capture may stimulate further neutron spallation: Directly in the gas/plasma (see FIG. 10) or inside a container with a fuel mix of enabling ingredients for neutron production and neutron capture (FIGS. 11, 13).

In option (2) neutrons are radiated out from a central neutron spallation unit, whereby the neutron capture unit is placed immediately outside, i.e. enclosing the neutron spallation unit. Regardless of options, the power/heat produced by neutron capture is transferred to one or more heat exchanger(s) enclosing the reactor. Multiple stacked medium sized reactor systems are applicable for electric power production via steam turbines, Stirling-Engines, etc. Considering the minute unit size (<1 m) and fuel required for the huge amount of energy produced, applications for power generators using neutron capture are abundant. An additional option applicable for space, is long-term electric power generation on deep space probes, i.e. converting neutron capture heat to electricity by thermoelectric generators like the RTG's on Pioneer 11, and Voyager 1/2, but now with no risk of plutonium contamination in case of accidents/re-entry.

As will be understood from the following power systems based on a neutron capture reactor, a wide range of applications is feasible. From single reactors (≈10 kW) for heating, to multiple/stacked systems generating electricity via steam turbines.

The power generator described here uses a scalable concept; deuterium ion spallation in a magnetic bottle accelerator, ion acceleration governed by ponderomotive wave forcing, specifically pulsed electric field directed perpendicular to the magnetic field. The MG wave-force is, as explained above, particularly well suited for acceleration of magnetized plasma in space. The latter is one reason for stimulating deuterium spallation via low-pressure (1-10⁻⁴ mbar) ion acceleration. Other reasons for low-pressure spallation are e.g. fuel delivery, power control, and safety aspects.

As already noted, the NSNC-process may occur jointly inside the reactor, as well as in separate neutron spallation and neutron capture units. Regardless of choice, the following design and control criteria should be considered:

(1) Avoidance of deuterium ion acceleration to excess energies (>2.3 MeV), preferably by limiting deuterium ion acceleration to just above 2.25 MeV thereby maximizing efficiency and energy return, and minimizing energy losses.

(2) Mitigate neutron escape, all neutrons must remain inside the reactor. To avoid neutron escape from the neutron capture reactor, an additional moderation and neutron capture shield, comprising e.g. saline water, may be used.

(3) Maintain full control of the input power (NS) versus output power (NC). The input power controlling neutron spallation, and therefore also the neutron capture output power is regulated by three parameters: The electrostatic acceleration voltage (Uₐ), the ICW frequency (f_{icw}), and the ICW E-field wave amplitude (E_{icw}). Uₐ enable fine-tuning of spallation energy while f_{icw} and E_{icw} are the main MG wave-forcing drivers for the spallation and neutron capture power output.

(4) Enable full quenching of excess energy from neutron-capture. Collisional quenching is a means to thermalize the energy output E_{c} in the neutron capture reaction ^{a}X+n=>^{a+1}X+E_{c}, where ^{a}X is the neutron capture isotope transmuted to ^{a+1}X, and E_{c} is the excess binding mass converted to energy. Neutron capture isotopes in solid state facilitate quenching, but high temperatures and a gas pressure in the mbar-range combined with collisions in the ceramic walls of the NSNC reactor may suffice for quenching.

(5) Continuous monitoring of latent ionizing radiation from the reactor. Continuous radiation monitoring of neutrons and gamma rays is besides a safeguard against radiation damage, also another means to control the NSNC process, against e.g. neutron capture meandering towards low-yield heavy elements.

(6) Identify suitable processes for heat exchange. A standard means of heat-exchange is to use water. Saline (KCl) water provides heat-exchange as well as intermediate energy supplier. The latter combining neutron moderation and ³⁵Cl capture of “escaping” neutrons, producing additional energy.

NSNC-generated energy/heat may also be used for electric power production. Large systems of multiple stacked NSNC reactors eventually transferring energy to electric generators driven by steam turbines, may serve such a purpose.

In what follows, six optional NSNC-reactor energy-producing systems are described.

FIG. 10a illustrates the first one, an NSNC reactor 600 charging chlorine gas 605 into the chamber with accelerated deuterium ions. As can be seen in FIG. 10b, the reactor 600 has a cylindrical shape wherein the interior forms a reaction chamber 601. An intermediate ceramic cylinder could be provided, acting as a protection shield for the electrostatic plates 420/421 which then are arranged in the chamber 604, cooled by a water heat exchanger 603. However, in the shown example the electrostatic plates 420-421 are arranged inside the reaction chamber 501. Notable, in this embodiment the reaction chamber 601 also forms an ion acceleration chamber. Neutron capture is expected to dominate where neutrons are most abundant, i.e. in the central region of the reactor. Internal heat production in the center may amplify the internal neutron spallation by gradient forcing, potentially to a self-perpetuating level when the gradient force from radiated heat attracts deuterium towards the high-temperature central core.

Neutron capture is enabled inside the reactor 600 (being identical to the reactor 400 shown in FIG. 6) by e.g. flushing the mix of deuterium and chlorine gas 605 into the reactor chamber 601. Alternatively, a metal target (not shown) with high neutron capture coefficient (e.g. cobalt, or nickel) may replace chlorine in the reactor center. To avoid the production of fast neutrons, the acceleration process should be fine-tuned to just about spallation energy. Fast neutrons can be moderated by water in the heat exchanger, thermal neutrons subsequently captured by chlorine in case water contains potassium chlorine.

In FIGS. 11a-b a cylindrical reactor 700 is now enclosing the spallation accelerator chamber 400 and a separate neutron capture cylinder 702 forming the reaction chamber. The acceleration chamber 400 is now fully dedicated for neutron production control. Neutron moderation, and neutron capture is here taking place in the cylindrical vessel 702 with saline water next to the accelerator 400, water for moderation and chlorine (e.g. KCl) for neutron capture. The enhanced temperature and pressure expected in the vessel 702 requires heat exchange to a water vessel 603 that can withstand high pressure.

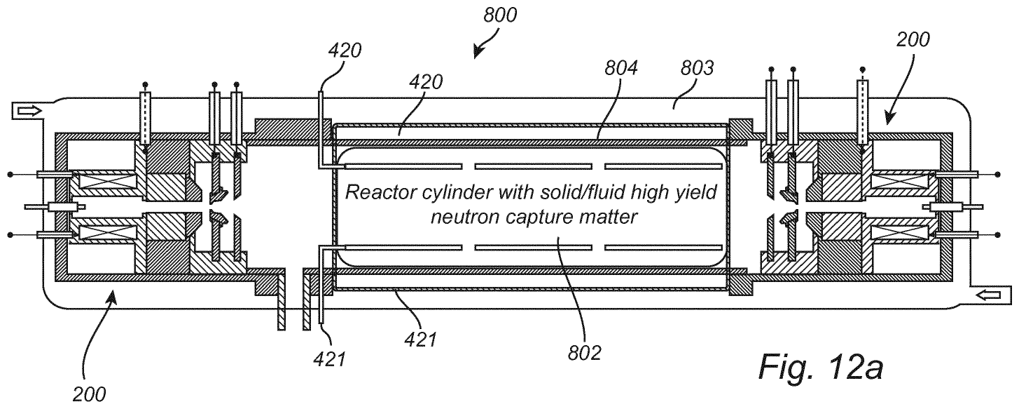

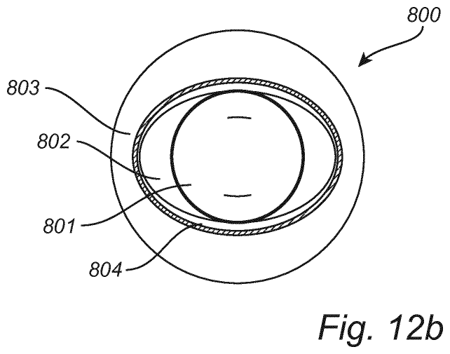

FIGS. 12a-2 shows another reactor 800, the inner cylinder 401 again dedicated for neutron spallation thus forming an ion acceleration chamber. The intermediate cylinder 802 now contains suitable solid elements with high neutron capture coefficient (e.g. KCl, nickel, cobalt) and high-energy yield, i.e. the intermediate cylinder 802 comprising the reaction chamber containing the fuel for neutron capture. The exterior cylinder 803 serves as heat exchanger, but also as moderator of fast neutrons the inner surface of the outer cylinder wall coated with e.g. cobalt (high neutron capture coefficient).

Regardless of the option, the NSNC reactors 600, 700, 800 displayed in FIGS. 10 to 12, an upright position is preferred for the reactor containers based on vacuum neutron spallation. The main reason for this is that a vacuum system requires more frequent re-filling (of deuterium) than a pure solid-state NSNC reactor. To maintain constant pressure in the accelerator, a continuous and balanced in-flow of “fresh” deuterium (²H) and out-flow of “waste” hydrogen (¹H) would be ideal (²H+Es=>¹H+n). Even with an inlet of deuterium higher than the “consumption”, it yet constitutes a minute sacrifice of deuterium mass compared to the gain in energy. Moreover, retrieval of non-spent deuterium in the outlet gas is feasible.

FIG. 13a-b shows a reactor version based on the principles described in FIGS. 4a-c, of which FIG. 4b is showing details of the plasma source and ion pre-accelerator unit 210 of the ion MG wave-accelerator 100. The main differences compared to the embodiment shown in FIG. 3B is plasma generation by discharges in front of the magnet, the discharges generating the electrostatic waves required for the MG-electrostatic wave acceleration. Beam-focusing, as illustrated in FIG. 13a, is governed by a “natural” process—besides the magnetic field divergence also the plasma density cavity formed as a result of enhanced ion outflow in the center of the local “plasma cloud” produced by electric discharges in the plasma generator.

While the previous energy generators are based on neutron capture outside the accelerator (FIGS. 11, 12) or by gaseous components inside the accelerator, the “fuel” in the embodiment shown in FIGS. 13a-b is solid (e.g. KCl) placed inside the accelerator. Furthermore, the container on the cathode-side 805 comprise besides KCl also a deuterium source (NClD⁴) to enable chain reactions. Chain reactions imply excess heat and high pressure inside the container 905, to the extent that separate efficient cooling is required 900, separated from the pre-accelerator 210. In fact, the purpose of the pre-accelerator 210 now serves the purpose of igniting the NSNC process 902, 905, and subsequently controlling the level of heat production. Notice that the container 902 as well as the cylinder container 102 is made of stainless steel, the former to allow for high pressure (e.g. 100 bar). The remaining part of the accelerator/reactor has a pressure in the mbar regime. Furthermore, to keep the solid “fuel” in place, the “fuel” is enclosed in a ceramic container 903.

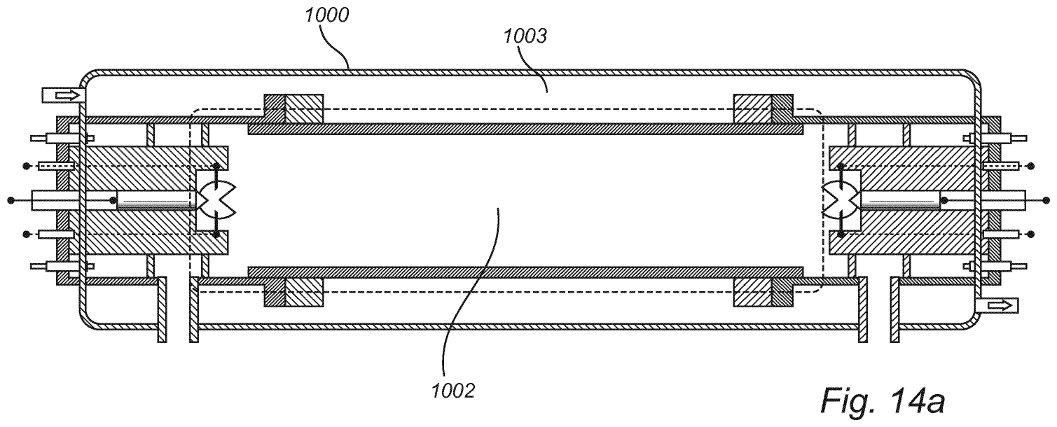

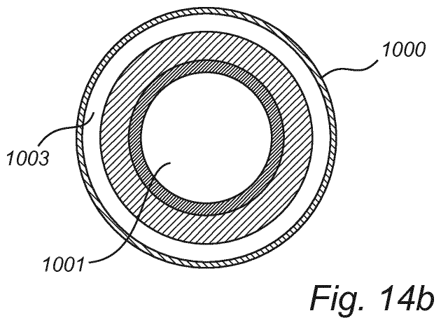

FIGS. 14a-b show a reactor version based on the principles described in FIG. 7 i.e. a two-sided electrostatic MG-wave accelerator. As mentioned earlier, FIG. 4b provides details of the plasma source and ion pre-accelerator unit 210 of the ion MG wave-accelerator 110. The reactor concept is similar to that described in FIGS. 11a-b, i.e. neutron capture takes place in the cylindrical vessel 1002 with saline water next to the accelerator 1001. Water for moderation and chlorine (e.g. KCl) for neutron capture. The heat exchanger 1003 is in this embodiment the water container enclosing the power generator. FIG. 14b shows a cross section of this power generator.

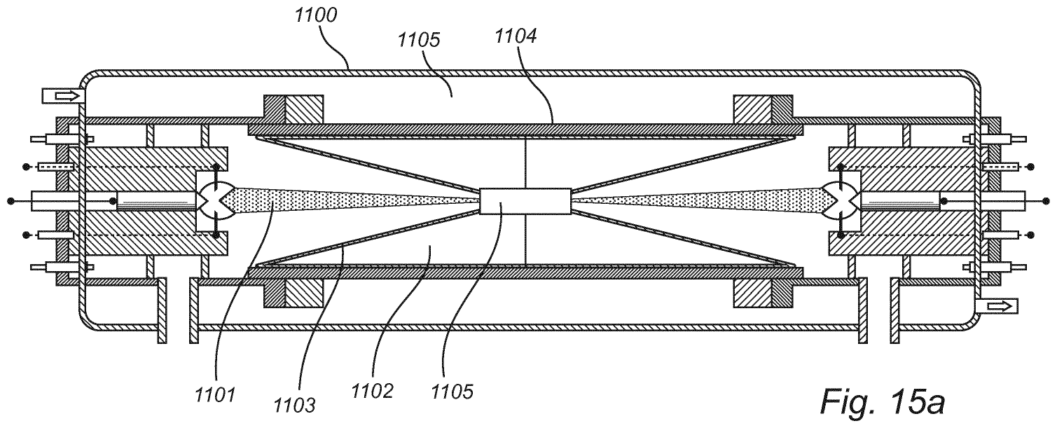

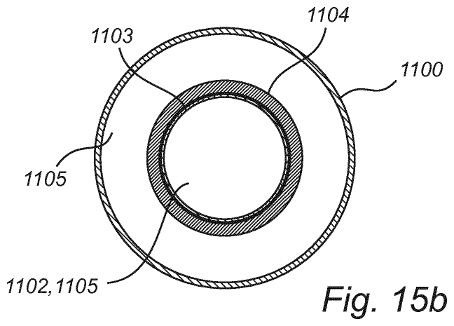

FIGS. 15a-b represent a twin version 1100 of the power generator shown in FIGS. 13a-b, now with a double neutron capture container 1102, 1101 with solid fuel (e.g. KCl and KCl+NClD⁴ respectively). The main advantage with the double configuration is that they may be operated individually or as pairs with double power output using the same heat exchanger 1105.

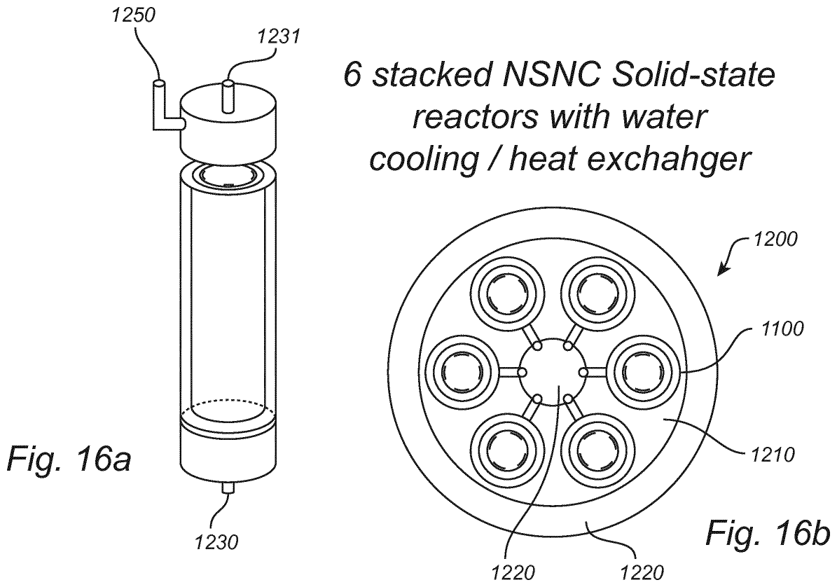

Finally, a stacked reactor assembly 1200 of the external solid-state NSNC reactor 1100 is displayed in FIGS. 16a-b. Each reactor 1100 capable of producing 8 kW power (in accordance with the simulation according to FIG. 9). The six reactors 1100 are embedded in an aluminum frame 1210 serving as heat exchanger to water, the entire system contained in a chamber 1100 that can withstand high pressure (water temperature>200° C.). The joint neutron spallation and heating of the six reactors 100 makes the total assembly 1200 more efficient, i.e. the total heat production becomes>50 kW.

The stacked assembly 1200 may comprise many more reactors 1000 than those illustrated by FIG. 13a-b. A 1 MW power supply would e.g. require 120 NSNC-reactors 1000, etc. Moreover, because the output power per reactor 1000 is scalable with the neutron production (and chlorine mass in neutron capture unit), the output power from the reactor 1000 can be significantly higher, the main problem then being thermal control and heat-exchange of the significantly higher nominal temperatures reached in the reactor cores. Although FIGS. 16a-b show the assembly 1200 comprising stacked reactors of the type shown in FIGS. 13a-b, it should be realized that also other reactor configurations, e.g. 700, 800, 1000 can be used in a stacked assembly 1200.

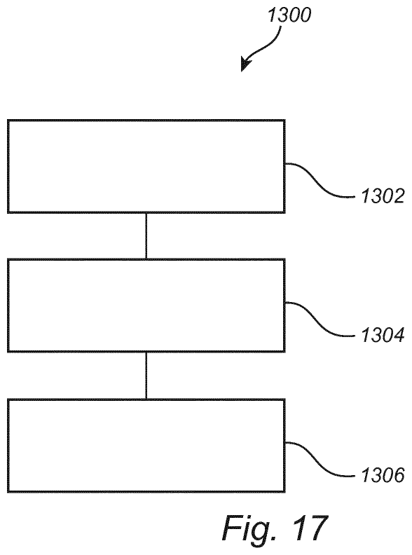

Now turning to FIG. 17 a method 1300 according to one aspect will be briefly described. The method 1300 is performed in order to accelerate ions, in particular deuterium ions, to an energy level required for neutron spallation, and to cause these neutrons to be captured by a fuel thus releasing energy. The method 1300 comprising a first step 1302 of extracting and pre-accelerate ions from a plasma source 200, and a subsequent step 1304 of inducing magnetic gradient wave-forcing of the ions thereby accelerating the ions to energy levels required for neutron spallation. A final step 1306 is performed in which released neutrons are captured by the fuel, leading to isotope transmutations and energy production.

1. A power generator, comprising a housing having two ends of which at least one end is provided with an ion source and ion pre-accelerator configured to induce neutron spallation, and a reaction chamber enclosing a fuel, wherein said reaction chamber is arranged to receive free neutrons from the plasma source.

2. The power generator according to claim 1, wherein the plasma source is configured to enable magnetic gradient wave-forcing of ions via electrostatic ion cyclotron waves in the diverging magnetic field.

3. The power generator according to claim 1, further comprising an ion acceleration chamber.

4. The power generator according to claim 3, wherein the ion acceleration chamber and the reaction chamber are formed as a common chamber.

5. The power generator according to claim 3, wherein the ion acceleration chamber is separate from the reaction chamber.

6. The power generator according to claim 5, wherein the reaction chamber is a cylindrical chamber arranged radially outside the ion acceleration chamber.

7. The power generator according to claim 1, further comprising an outer chamber surrounding said reaction chamber and/or said ion acceleration chamber.

8. The power generator according to claim 7, wherein said outer chamber contains saline water.

9. The power generator according to claim 1, wherein said ion source and ion pre-accelerator is configured to induce magnetic gradient wave-forcing of ions by providing electromagnetic waves or electrostatic ion cyclotron waves in the diverging magnetic field.

10. The power generator according to claim 9, further comprising an induction coil arranged around said housing.

11. The power generator according to claim 9, further comprising at least two capacitive plates, and an anode-cathode high voltage-discharge unit inside said housing.

12. The power generator according to claim 1, wherein the length of said housing is between 0.1 m and 1.0 m, preferably between 0.2 m and 0.5 m.

13. The power generator according to claim 1, wherein both ends of said housing are provided with a respective plasma source.

14. The power generator according to claim 1, wherein said plasma source and ion pre-accelerator are configured to produce an energetic ion beam.

15. The power generator according to claim 1, wherein an Ignition Coil Generator (ICG) discharge source and an ion pre-accelerator are configured to produce, besides an energetic ion beam, also electrostatic waves required for MG-wave acceleration up to spallation energies.

16. The power generator according to claim 1, wherein said ion beam from the pre-accelerator is extracted from ionized deuterium gas supplied externally, and wherein said reaction chamber encloses chlorine gas, KCl, or mix of other elements prone to neutron capture.

17. A generator assembly, comprising a frame in which a plurality of power generators according to claim 1 is embedded.

18. The generator assembly according to claim 1, wherein the frame is made of aluminum.

19. The generator assembly according to claim 17, wherein the frame and the plurality of power generators are enclosed within a chamber.

20. An ion accelerator for use with a power generator according to claim 1, comprising a housing having two ends of which at least one end is provided with a plasma source from which ions are extracted and pre-accelerated, and wherein said ion source is configured to enable magnetic gradient wave-forcing of ions via electromagnetic or electrostatic ion cyclotron waves in the magnetic field.

21. The ion accelerator according to claim 20, wherein the magnetic gradient wave-forcing of ions is achieved by means of an induction coil or at least one pair of capacitive plates arranged around or at the periphery of said housing.

22. The ion accelerator according to claim 20, wherein the magnetic gradient electrostatic wave-forcing of ions is achieved by means of an Ignition Coil Generator (ICG) being configured to produce a localized plasma cloud as well as electrostatic waves.

23. A method for providing neutron capture, comprising pre-accelerating deuterium ions from a plasma source, inducing magnetic gradient wave-forcing of the ions thereby accelerating the ions to an energy level required for neutron spallation, and allowing the released neutrons to interact with a fuel thus causing an isotope shift of said fuel.

24. The method according to claim 23, wherein the magnetic gradient wave-forcing of the ions is achieved by means of an induction coil arranged around a housing of an ion accelerator.

25. The method according to claim 23, wherein the MG electrostatic wave-forcing of the ions is achieved by means of an ICG arranged in the pre-accelerator.

26. The method according to claim 24, wherein the magnetic gradient wave forcing of the ions is achieved by means of a plurality of capacitive coupled electric field plates acting as high voltage discharge units arranged around or inside a housing of an ion accelerator, and electrostatic waves, optionally provided by means of an ICG.
